(19) United States
(12) Patent Application Publication
(10) Pub. No.: US 2026/0131459 A1
(43) Pub. Date: May 14, 2026

(54) CONTROL DEVICE, CONTROL METHOD, AND CONTROL PROGRAM

(71) Applicant: OMRON CORPORATION, Kyoto-shi, Kyoto (JP)

(72) Inventors: Kazutoshi TANAKA, Bunkyo-ku, Tokyo (JP); Tatsunori TANIAI, Bunkyo-ku, Tokyo (JP); Sotaro KATAYAMA, Bunkyo-ku, Tokyo (JP)

(73) Assignee: OMRON CORPORATION, Kyoto-shi, Kyoto (JP)

(21) Appl. No.: 19/115,604

(22) PCT Filed: Oct. 12, 2023
(86) PCT No.: PCT/JP2023/037119

§ 371 Date: Mar. 26, 2025

(30) Foreign Application Priority Data
Oct. 20, 2022 (JP) 2022-168713

(51) Int. Cl. B25J 9/16

(52) U.S. Cl. CPC B25J 9/1633; G05B 2219/39001

(57) ABSTRACT

A control device that acquires a state of a control object at a time point t and calculates a state of the control object at a time point t+1 so as to satisfy a complementarity condition and minimize an objective function. The complementarity condition relates to a contact force generated at a contact point at the control object and a distance between the control object and the contact point. The objective function represents a difference between the state at the time point t+1 and a target value. The control device controls the control object so as to achieve the calculated state at the time point t+1.

### TECHNICAL FIELD

The present disclosure relates to a control device, a control method, and a control program.

### BACKGROUND ART

Heretofore, technology has been known (for example, see Japanese Patent Application Laid-Open (JP-A) No. 2007-30054) that, when a robot has conducted various physical interactions with the outer world, measures both a contact state and an active force at an arbitrary location of a body.

Further technology has been known (for example, see Reference 1: Bernardo Aceituno-Cabezas and Alberto Rodriguez, “A Global Quasi-Dynamic Model for Contact-Trajectory Optimization”, Robotics: Science and Systems 2020 Corvallis, Oregon, USA, Jul. 12-16, 2020, Internet URL:

<https://www.researchgate.net/publication/342882025>. Accessed Sep. 27, 2022) relating to how, when a robot makes contact with a body, the robot should make contact with the body in order to achieve a target trajectory. Reference 1 proposes a global optimization model for when a robot contacts a body.

### SUMMARY OF INVENTION

### Technical Problem

For example, in a situation in which a robot moves to contact a body, a contact state between the robot and the body (below referred to simply as a contact mode) successively changes. Therefore, physical constraints on movements of the robot 10 successively change. Consequently, when there are many contacts between the robot and the body, suitably controlling movements of the robot is difficult.

The present disclosure is made in consideration of the matter described above. An object of the present disclosure is to control a control object so as to satisfy complementarity conditions relating to contact forces generated at contact points of the control object and distances between the control object and the contact points.

### Solution to Problem

To achieve the object described above, a control device according to the present disclosure includes: an acquisition section that acquires a state of a control object at a time point t; a calculation section that, on the basis of the state at the time point t, calculates a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and a control section that controls the control object so as to achieve the calculated state at the time point t+1.

The calculation section may, on the basis of the state at the time point t, calculate the state at the time point t+1 so as to satisfy the complementarity condition relating to the contact force generated at the contact point at the control object and the distance between the control object and the contact point and a complementarity condition relating to a linear contact velocity at a contact surface contacted by the contact point, and so as to minimize the objective function representing the difference between the state of the control object at the time point t+1 and the target value.

The meaning of the term “control object” as used herein is intended to include a mechanism controlled by the control device and an object body affected by actions by the mechanism, and the mechanism may include a robot. The meaning of the term “state” is intended to include positions and attitudes of the mechanism and the object body. The meaning of the term “time point t+1” is intended to include a time point advanced by a unit of time in calculations from the time point t, which may include a cycle time of the control device, a cycle time of calculations by a computer, and a cycle time of a simulation by a computer. The meaning of the term “target value” is intended to include a state specified in advance to be achieved by the mechanism and/or the object, and may include coordinates and an attitude. The meaning of the term “minimize” is intended to include calculating a value from an objective function, which may include an error caused by a calculation method.

The control object may be each of a robot and an object body, data of the states may be calculated on the basis of sensor data obtained by a sensor that senses states of the robot and the object body, and the calculation section may, on the basis of the states at the time point t, calculate the states of the control objects at the time point t+1 so as to satisfy complementarity conditions that each relate to a contact force generated between two of a contact point of the robot, a contact point of the object body, and a contact point of another body, and a distance between the two of the contact point of the robot, the contact point of the object body, and the contact point of the another body.

The complementarity conditions may include, for each of plural the contact points: a complementarity condition (4a) relating to, in the state qₜ at the time point t, a contact force λₙᵢ generated in a perpendicular direction of a contact surface contacted by an i-th contact point and a distance φᵢ(qₜ) between the i-th contact point and the contact surface; a complementarity condition (4b) relating to, in the state qₜ at the time point t with a generalized velocity vₜ at the time point t, a contact force λ_{fi+} in a first horizontal direction of the contact surface contacted by the i-th contact point, a signed linear contact velocity ψᵢ(qₜ, vₜ) that is positive in the first horizontal direction of the contact surface, and an absolute value γᵢ of the linear contact velocity; a complementarity condition (4c) relating to, in the state qₜ at the time point t with the generalized velocity vₜ at the time point t, a contact force λ_{fi-} in a second horizontal direction of the contact surface contacted by the i-th contact point, the signed linear contact velocity ψᵢ(qₜ, vₜ), and the absolute value γᵢ of the linear contact velocity; and a complementarity condition (4d) relating to, at the contact surface contacted by the i-th contact point, the absolute value γᵢ of the linear contact velocity, a coefficient of friction μᵢ of the contact surface, the contact force λₙᵢ generated in the perpendicular direction of the contact surface, the contact force λ_{fi+} in the first horizontal direction, and the contact force λ_{fi-} in the second horizontal direction.

$$0 \leq {λ}_{{n}_{i}} ⊥ {ϕ}_{i} ( {q}_{t} ) \geq 0 , \qquad ( 4 a )$$

$$0 \leq {λ}_{{f}_{i} +} ⊥ {γ}_{i} + {ψ}_{i} ( {q}_{t} , {υ}_{t} ) \geq 0 , \qquad ( 4 b )$$

$$0 \leq {λ}_{{f}_{i} -} ⊥ {γ}_{i} + {ψ}_{i} ( {q}_{t} , {υ}_{t} ) \geq 0 , \qquad ( 4 c )$$

$$0 \leq {γ}_{i} ⊥ {μ}_{i} {λ}_{{n}_{i}} - {λ}_{{f}_{i} +} - {λ}_{{f}_{i} -} \geq 0 , \qquad ( 4 d )$$

The calculation section may, on the basis of the state qₜ at the time point t, calculate the state qₜ₊₁ at the time point t+1 so as to satisfy the complementarity conditions (4a) to (4d) and minimize an objective function (5).

$$\frac{1}{2} {( g ( {q}_{t + 1} ) - {g}_{ref} )}^{T} {Q}_{g} ( g ( {q}_{t + 1} ) - {g}_{ref} ) + \frac{1}{2} {υ}_{t}^{T} {Q}_{υ} {υ}_{t} + \frac{1}{2} {λ}_{t + 1}^{T} {Q}_{f} {λ}_{t + 1} , \qquad ( 5 )$$

In this expression, g(qₜ₊₁) represents a physical quantity of the control object corresponding to the state qₜ₊₁, g_{ref} represents a target value of the physical quantity of the control object corresponding to the target value in the state qₜ₊₁, Q_{g}, Qᵥ and Q_{f} represent positive-definite weighting arrays provided in advance, and λₜ₊₁ represents a vector at the time point t+1 for each of the plural contact points, components of the vector being the contact force λₙᵢ generated in the perpendicular direction of the contact surface, the contact force λ_{fi+} in the first horizontal direction and the contact force λ_{fi-} in the second horizontal direction.

The complementarity conditions may include, for each of plural the contact points: a linear complementarity condition (7a) relating to, in the state qₜ at the time point t, a contact force λₙᵢ generated in a perpendicular direction of a contact surface contacted by an i-th contact point, an amount of change Δλₙᵢ of the contact force λₙᵢ, a distance φᵢ(qₜ) between the i-th contact point and the contact surface, Φ_{i,q}(qₜ) obtained by differentiating the distance φᵢ(qₜ) with respect to the state qₜ, and an amount of change Δqₜ of the state qₜ; a linear complementarity condition (7b) relating to, in the state qₜ at the time point t with a generalized velocity vₜ at the time point t, a contact force λ_{fi+} in a first horizontal direction of the contact surface contacted by the i-th contact point, an amount of change Δλ_{fi+} of the contact force λ_{fi+}, a signed linear contact velocity ψᵢ(qₜ, vₜ) that is positive in the first horizontal direction of the contact surface, Ψ_{i,v}(qₜ, vₜ) obtained by differentiating the linear contact velocity ψᵢ(qₜ, vₜ) with respect to the generalized velocity vₜ, an absolute value γᵢ of the linear contact velocity, and an amount of change Δqₜ of the state qₜ; a linear complementarity condition (7c) relating to, in the state qₜ at the time point t with the generalized velocity vₜ at the time point t, a contact force λ_{fi-} in a second horizontal direction of the contact surface contacted by the i-th contact point, an amount of change Δλ_{fi-} of the contact force λ_{fi-}, the signed linear contact velocity ψᵢ(qₜ, vₜ), the absolute value γᵢ of the linear contact velocity, and the Ψ_{i,v}(qₜ, vₜ) obtained by differentiating the linear contact velocity ψᵢ(qₜ, vₜ) with respect to the generalized velocity vₜ; and a linear complementarity condition (7d) relating to, at the contact surface contacted by the i-th contact point, the absolute value γᵢ of the linear contact velocity, a coefficient of friction μᵢ of the contact surface, the contact force λₙᵢ generated in the perpendicular direction of the contact surface, the amount of change Δλₙᵢ of the contact force λₙᵢ, the contact force λ_{fi+} in the first horizontal direction, the amount of change Δλ_{fi+} of the contact force λ_{fi+} in the first horizontal direction, the contact force λ_{fi-} in the second horizontal direction, and the amount of change Δλ_{fi-} of the contact force λ_{fi-} in the second horizontal direction.

$$0 \leq {λ}_{{n}_{i}} + Δ {λ}_{{n}_{i}} ⊥ {ϕ}_{i} ( {q}_{t} ) + {Φ}_{i , q} ( {q}_{t} ) Δ {q}_{t} \geq 0 , \qquad ( 7 a )$$

$$0 \leq {λ}_{{f}_{i} +} + {Δλ}_{{f}_{i} +} ⊥ {γ}_{i} + {ψ}_{i} ( {q}_{t} , {υ}_{t} ) + {Ψ}_{i , υ} ( {q}_{t} , {υ}_{t} ) Δ {q}_{t} \geq 0 , \qquad ( 7 b )$$

$$0 \leq {λ}_{{f}_{i} -} + {Δλ}_{{f}_{i} +} ⊥ {γ}_{i} - {ψ}_{i} ( {q}_{t} , {υ}_{t} ) - {Ψ}_{i , υ} ( {q}_{t} , {υ}_{t} ) Δ {q}_{t} \geq 0 , \qquad ( 7 c )$$

$$0 \leq {γ}_{i} ⊥ {μ}_{i} ( {λ}_{{n}_{i}} + {Δλ}_{{n}_{i}} ) - {λ}_{fi +} - {Δλ}_{fi +} - {λ}_{fi -} - {Δλ}_{fi -} \geq 0 , \qquad ( 7 d )$$

The calculation section may, on the basis of the state qₜ at the time point t, calculate the state qₜ₊₁ at the time point t+1 by calculating an amount of change Δqₜ of the state so as to satisfy the complementarity conditions (7a) to (7d) and minimize an objective function (6).

$$\frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {q}_{t}^{T} {Q}_{Δ q} Δ {q}_{t} + \frac{1}{2} {( {λ}_{t} + {Δλ}_{t} )}^{T} {Q}_{f} ( {λ}_{t} + {Δλ}_{t} ) , \qquad ( 6 )$$

$${g}_{t} := g ( {q}_{t} ) ,$$

$${G}_{t} := \frac{\partial g}{\partial q} g ( {q}_{t} ) ,$$

$${Q}_{Δ q} := \frac{1}{{h}^{2}} {Q}_{υ} ,$$

$${q}_{t + 1} = {q}_{t} + h {υ}_{t} ,$$

In this expression, gt represents a physical quantity of the control object corresponding to the state qₜ, g_{ref} represents a target value of the physical quantity of the control object corresponding to the target value in the state qₜ, Q_{g}, Qᵥ and Q_{f} represent positive-definite weighting arrays provided in advance, λₜ represents a vector at the time point t for each of the plural contact points, components of the vector being the contact force λₙᵢ generated in the perpendicular direction of the contact surface, the contact force λ_{fi+} in the first horizontal direction and the contact force λ_{fi-} in the second horizontal direction, and Δλₜ represents an amount of change of λₜ.

The complementarity conditions may include a relaxation variable sᵢ as below for relaxing the complementarity conditions.

$$0 \leq {λ}_{{n}_{i}} + {Δλ}_{{n}_{i}} + {s}_{i} ⊥ {ϕ}_{i} ( {q}_{t} ) + {Φ}_{q , i} ( {q}_{t} ) Δ {q}_{t} + {s}_{i} \geq 0 , \qquad ( 9 a )$$

$$0 \leq {λ}_{{f}_{i} +} + {Δλ}_{{f}_{i} +} + {s}_{i} ⊥ {γ}_{i} + {ψ}_{i} ( {q}_{t} , {υ}_{t} ) + {Ψ}_{υ , i} ( {q}_{t} , {υ}_{t} ) Δ {q}_{t} + {s}_{i} \geq 0 , \qquad ( 9 b )$$

$$0 \leq {λ}_{{f}_{i} -} + {Δλ}_{{f}_{i} +} + {s}_{i} ⊥ {γ}_{i} - {ψ}_{i} ( {q}_{t} , {υ}_{t} ) - {Ψ}_{υ , i} ( {q}_{t} , {υ}_{t} ) Δ {q}_{t} + {s}_{i} \geq 0 , \qquad ( 9 c )$$

$$0 \leq {γ}_{i} + {s}_{i} ⊥ {μ}_{i} ( {λ}_{{n}_{i}} + {Δλ}_{{n}_{i}} ) - {λ}_{{f}_{i} +} - {Δλ}_{{f}_{i} +} - {λ}_{{f}_{i} -} - {Δλ}_{{f}_{i} -} + {s}_{i} \geq 0. \qquad ( 9 d )$$

The calculation section may, on the basis of the state qₜ at the time point t, calculate the state qₜ₊₁ at the time point t+1 by calculating a vector sₜ so as to satisfy the complementarity conditions (9a) to (9d) and minimize an objective function (10), components of the vector sₜ being an amount of change Δqₜ of the state, an amount of change Δλₜ of the contact force and the relaxation variable sᵢ.

$${min}_{Δ {q}_{t} , {Δλ}_{t} , {s}_{t}} \frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {q}_{t}^{T} {Q}_{Δ {q}_{t}} Δ {q}_{t} + \frac{1}{2} {( {λ}_{t} + {Δλ}_{t} )}^{T} {Q}_{f} ( {λ}_{t} + {Δλ}_{t} ) + {\sum }_{i} {p}_{i} {s}_{i}^{2} \qquad ( 10 )$$

$$s . t . ( 8 ) - ( 9 d ) .$$

$${g}_{t} := g ( {q}_{t} ) ,$$

$${G}_{t} := \frac{\partial g}{\partial q} g ( {q}_{t} ) ,$$

$${Q}_{Δ q} := \frac{1}{{h}^{2}} {Q}_{υ} ,$$

$${q}_{t + 1} = {q}_{t} + h {υ}_{t} ,$$

In this expression, gt represents a physical quantity of the control object corresponding to the state qₜ, g_{ref} represents a target value of the physical quantity of the control object corresponding to the target value in the state qₜ, Q_{g}, Qᵥ and Q_{f} represent positive-definite weighting arrays provided in advance, λₜ represents a vector at the time point t for each of the plural contact points, components of the vector being the contact force λₙᵢ generated in the perpendicular direction of the contact surface, the contact force λ_{fi+} in the first horizontal direction and the contact force λ_{fi-} in the second horizontal direction, and Δλₜ represents an amount of change of λₜ.

A control method according to the present disclosure includes causing a computer to execute processing including: acquiring a state of a control object at a time point t; on the basis of the state at the time point t, calculating a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and controlling the control object so as to achieve the calculated state at the time point t+1.

A control program according to the present disclosure causes a computer to execute processing including: acquiring a state of a control object at a time point t; on the basis of the state at the time point t, calculating a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and controlling the control object so as to achieve the calculated state at the time point t+1.

### Advantageous Effects of Invention

According to the control device, method and program of the present disclosure, a control object may be controlled so as to satisfy complementarity conditions relating to contact forces generated at contact points of the control object and distances between the control object and the contact points.

### BRIEF DESCRIPTION OF DRAWINGS

FIG. 1 is a diagram for describing an outline of a present exemplary embodiment.

FIG. 2 is a diagram for describing a flow of processing executed by a control system according to the present exemplary embodiment.

FIG. 3 is a diagram for explaining a state qₜ that is used in the present exemplary embodiment.

FIG. 4 is a diagram for describing a relationship between a distance between a contact point and a contact surface and a contact force.

FIG. 5A to FIG. 5C are diagrams for describing a Coulomb friction coefficient between a contact point and a contact surface.

FIG. 6 is a block diagram showing functional structures of a control system according to the present exemplary embodiment.

FIG. 7 is a block diagram showing hardware structures of the control device according to the present exemplary embodiment.

FIG. 8 is a flowchart showing a flow of control processing according to the present exemplary embodiment.

FIG. 9 is a diagram for describing a present Example.

FIG. 10 is a diagram depicting results of the present Example.

FIG. 11 is a diagram for explaining the results of the present Example.

FIG. 12 is a diagram depicting the results of the present Example.

FIG. 13 is a diagram for describing conventional technology.

### DETAILED DESCRIPTION

Below, an example of an embodiment of the present disclosure is described with reference to the drawings. In the present exemplary embodiment, a control system in which a control device according to the present disclosure is installed is described as an example. In the drawings, the same reference symbols are assigned to structural elements and portions that are the same or equivalent. Dimensions and proportions in the drawings may be exaggerated to aid understanding and may be different from actual proportions.

### Outline of the Exemplary Embodiment

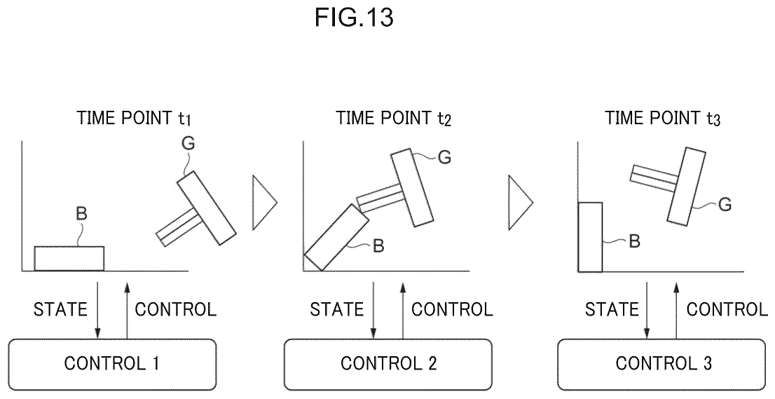

FIG. 13 is a diagram for describing an example of conventional technology. As illustrated in FIG. 13, the conventional technology implements control 1 in accordance with a contact mode between an object B and a gripper part G of a robot at a time point t1, implements control 2 in accordance with a contact mode at a time point t2, and implements control 3 in accordance with a contact mode at a time point t3. In this situation, movements of the robot must be controlled in accordance with the contact modes between the object body B and the gripper part G of the robot. However, because a number of contact modes is very large, continuously controlling the robot in accordance with the multitudinous contact modes is difficult.

Accordingly, the present exemplary embodiment continuously controls movements of a robot so as to satisfy complementarity conditions relating to contacts between bodies. As a result, movements of the robot may be controlled in real time.

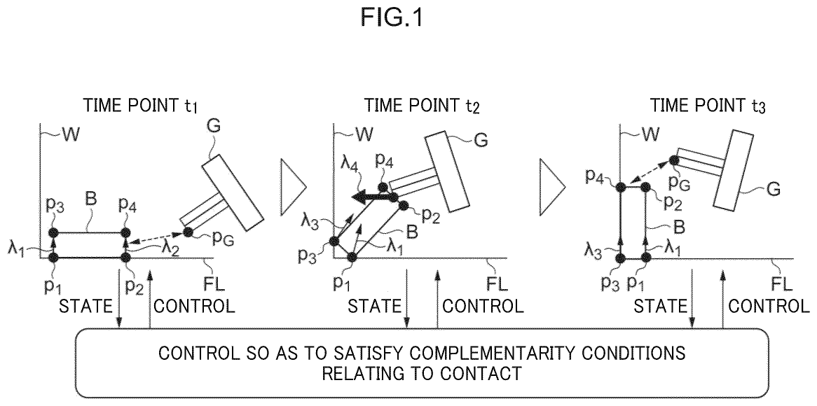

FIG. 1 is a diagram for describing an outline of the present exemplary embodiment. As shown in FIG. 1, the present exemplary embodiment takes account of complementarity conditions relating to contacts between an object body B, a gripper part G of a robot, and another object, a wall W or a floor surface FL. The object body B and the gripper part G of the robot are examples of a control object of the present disclosure.

More specifically, as shown in FIG. 1, at a time point t1, the gripper part G of the robot is not in contact with the object body B. Therefore, a distance between a contact point p_{G} of the gripper part G and the object body B is greater than zero, and a contact force generated at the contact point p_{G} of the gripper part G of the robot is zero. At the time point t1, because the contact point pG is not actually in contact with the object body B, the contact point p_{G} is a contact candidate point.

Then, at a time point t2 as shown in FIG. 1, the gripper part G of the robot is in contact with the object body B. Therefore, the distance between the contact point p_{G} of the gripper part G and the object body B is zero, and a contact force λ₄ generated at the contact point p_{G} of the gripper part G of the robot is greater than zero.

Then, at a time point t3 as shown in FIG. 1, the gripper part G of the robot is not in contact with the object body B. Therefore, the distance between the contact point p_{G} of the gripper part G and the object body B is greater than zero, and the contact force generated at the contact point p_{G} of the gripper part G of the robot is zero.

As illustrated in FIG. 1, the object body B has plural contact points p₁, p₂, p₃ and p₄. For example, at the time point t1, a contact force λ₁ is generated between the contact point p₁ and the floor surface FL and a contact force 22 is generated between the contact point p₂ and the floor surface FL. At the time point t₂, a contact force λ₁ is generated between the contact point p₁ and the floor surface FL, and a contact force λ₃ is generated between the contact point p₃ and the wall W. At the time point t3, a contact force λ₁ is generated between the contact point p₁ and the floor surface FL, and a contact force λ₃ is generated between the contact point p₃ and the floor surface FL.

As illustrated in FIG. 1, each contact force is zero when the corresponding distance between the gripper part G of the robot and the object body B or between the object body B and the wall W or floor surface FL is greater than zero. On the other hand, each contact force is greater than zero when the corresponding distance between the gripper G of the robot and the object body B or between the object body B and the wall W or floor surface FL is zero. Therefore a complementarity condition applies between a distance between bodies and a contact force generated between the bodies.

Accordingly, the present exemplary embodiment continuously controls movements of a robot so as to satisfy complementarity conditions relating to contacts between bodies. Therefore, without controlling the robot on the basis of multiple contact modes as in the conventional technology in FIG. 13, movements of the robot may be controlled in real time. A complementarity condition between two scalar variables a and b can be represented by the following expression (1).

$$0 \leq a ⊥ b \geq 0 , \qquad ( 1 )$$

The variables a and b also satisfy the following expressions.

$$a , b \geq 0$$

$$ab - 0.$$

Herebelow, a method proposed in the present exemplary embodiment is referred to as a linear complementarity quadratic program (LCQP).

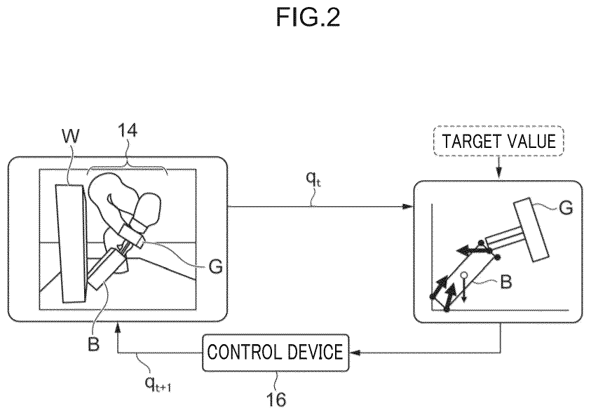

FIG. 2 is a diagram for describing a flow of processing executed by a control system according to the present exemplary embodiment. As shown in FIG. 1, a control device 16 according to the present exemplary embodiment acquires a state qₜ of a control object at a time point t and calculates a state qₜ₊₁ of the control object at a time point t+1 so as to make a difference from a target value small. Here, the control device 16 calculates the state qₜ₊₁ of the control object at the time point t+1 so as to satisfy complementarity conditions relating to contacts between bodies and so as to decrease an objective function representing the difference between the target value and the state qₜ₊₁ of the control object at the time point t+1. The control device 16 outputs the state qₜ₊₁ of the control object at the time point t+1 to a robot 14 as a control input. Thus, movements of the robot may be controlled in real time without successively specifying contact modes in response to changes of the control object. In the present exemplary embodiment, because just determining whether or not complementarity conditions relating to contacts between bodies are satisfied is sufficient, calculation costs when controlling movements of a robot in real time may be reduced.

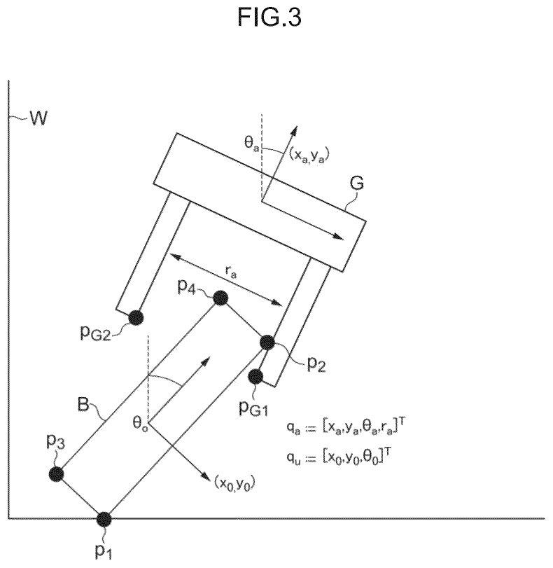

FIG. 3 is a diagram for explaining the state qₜ used in the present exemplary embodiment. FIG. 3 is a diagram depicting an example of a quasi-static formularization in which a whole system is structured by the gripper part G and the object body B. As illustrated in FIG. 3, a state vector qₐ of the gripper part G is specified in the present exemplary embodiment. Components of the state vector qₐ are coordinates (xₐ,yₐ) in a gripper part coordinate system, whose origin point is a predetermined position of the gripper part G, an attitude angle θₐ representing an attitude of the gripper part G, and a distance rₐ between grippers with which the gripper part G is equipped. As illustrated in FIG. 3, in the present exemplary embodiment a state vector qᵤ of the object body B is also specified, whose components are coordinates (x₀,y₀) in an object body coordinate system, whose origin point is a predetermined position of the object body B, and an attitude angle θ₀ representing an attitude of the object body B. If all degrees of freedom (DOF) of the gripper part G are represented by Nu and all degrees of freedom of the object body B are represented by Nₐ, the state vector qₐ and the state vector qᵤ in a generalized coordinate system are defined by the following expressions. Herebelow, boldface symbols in mathematical expressions represent vectors and matrices.

$${q}_{a} ∈ {ℝ}^{{N}_{a}}$$

$${q}_{u} ∈ {ℝ}^{{N}_{u}}$$

States q of the control object and velocities v of the bodies can be expressed by the following expressions. The velocities v are generalized velocities.

$$q = {[ {q}_{a}^{T} {q}_{u}^{T} ]}^{T}$$

$$υ = {[ {υ}_{a}^{T} {υ}_{u}^{T} ]}^{T}$$

Expanding the quasi-static model over a discrete period, the following expression can be derived, in which h represents a coefficient specified in advance that is at least zero.

$${q}_{t + 1} = {q}_{t} + h {υ}_{t} , \qquad ( 2 )$$

Now, contact forces are described, which are forces generated between contact points and contact surfaces. As shown in FIG. 3, a corner of the object body B and a corner of a gripper provided at the gripper part G are specified as contact points p_{G1} and p_{G2}. A contact force λ_{t,i} generated between an i-th contact point and contact surface is defined as follows.

$${λ}_{t , i} = {[ {λ}_{{f}_{i}} , {λ}_{{n}_{i}} ]}^{T} ∈ {ℝ}^{2}$$

$${λ}_{{f}_{i}} , {λ}_{{n}_{i}} ∈ ℝ$$

λ_{fi} is a contact force in a horizontal direction of the contact surface contacted by the i-th contact point, and λₙᵢ is a contact force generated in a perpendicular direction of the contact surface contacted by the i-th contact point. In the present exemplary embodiment, an example is described in which the object body B is a box, but complementarity conditions may be formularized in a similar manner for other types of body (for example, spherical bodies).

Next, in order to derive a balance between forces and moments acting on an object o, which corresponds to the object body B, a collection Cₒ of pairs of contact points and contact surfaces is derived. An index i for distinguishing the pairs of contact points and contact surfaces is defined by the following expressions.

The index i for distinguishing the pairs of contact points and contact surfaces associates a rotation matrix Rᵢ(qₜ) of a contact surface defined by the following expression with relative positions [r_{o,i,x}(qₜ), r_{o,i,y}(qₜ)]^{T} from a center of gravity of the contact surface.

$$\begin{matrix}{R}_{i} ( {q}_{t} ) ∈ {ℝ}^{2 \times 2} \\ {[ {r}_{o , i , x} ( {q}_{t} ) {r}_{o , i , y} ( {q}_{t} ) ]}^{T} .\end{matrix}$$

Under quasi-static assumptions (for example, that velocity and acceleration are sufficiently small), Newton's second law in relation to object o can be represented by the following expression (3).

$${b}_{o} ( {q}_{t} , {\{ {λ}_{t , i} \}}_{i ∈ {C}_{0}} ) := {\sum }_{i ∈ {C}_{0}} [ \begin{matrix}{R}_{i} ( {q}_{t} ) {λ}_{t , i} \\ {\tilde{r}}_{o , i}^{T} ( {q}_{t} ) {R}_{i} ( {q}_{t} ) {λ}_{t , i}\end{matrix} ] + {F}_{o} = 0 , \qquad ( 3 )$$

The symbols r_{o,i}^{˜}(qₜ) in the above expression can be represented by the following expression.

$${r}_{o , i} ( {q}_{t} ) := {[ - {r}_{o , i , y} ( {q}_{t} ) , {r}_{o , i , x} ( {q}_{t} ) ]}^{T} ∈ {ℝ}^{2} .$$

A first dimension component and a second dimension component of a vector represented by expression (3) represent forces acting on the object o in a global coordinate system. Similarly, a third dimension component in expression (3) represents a moment. The forces and moment written in the brackets of expression (3) represent contact forces acting on the object o. A force Fₒ defined by the following expression represents forces that are constant over time such as gravity and the like. The values shown in expression (3) may be calculated by previously known technologies.

$${F}_{o} ∈ {ℝ}^{3}$$

### —Complementarity Conditions Relating to Contacts—

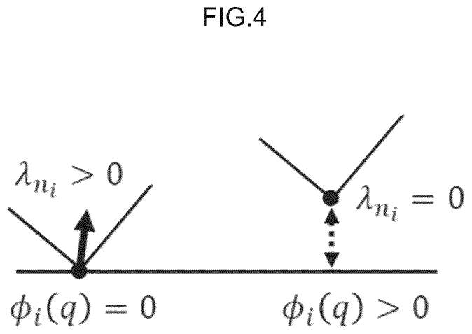

In the present exemplary embodiment, a contact force vector λ_{t,i} generated at a time point t is defined for each of the indexes i distinguishing the pairs of contact points and contact surfaces. As mentioned above, components of the contact force vector λ_{t,i} are a contact force λₙᵢ generated in the perpendicular direction of the contact surface at the i-th pair of contact point and contact surface and a contact force Mi generated in a horizontal direction of the contact surface at the i-th pair of contact point and contact surface. FIG. 4 is a diagram for describing a relationship between a distance φᵢ(q) between the i-th contact point and contact surface and the contact force λₙᵢ. As shown in FIG. 4, when the distance φᵢ(q)=0, the contact force λₙᵢ>0, and when the distance φᵢ(q)>0, the contact force λₙᵢ=0.

When a contact point of the gripper part G of the robot 14 contacts the object body B as illustrated in the above-described FIG. 1 and the distance between the contact point of the gripper part G and the object body B is zero, the contact force λₙᵢ is positive. Accordingly, in the present exemplary embodiment the distance φᵢ(qₜ) between the i-th contact point and contact surface at the time point t is derived. The distance φᵢ(qₜ) can be represented by the following expression.

$${ϕ}_{i} ( {q}_{t} ) ∈ ℝ$$

In order for the object body B or the gripper part G to not slide at the contact point, the contact force vector λ_{t,i} must be located in a friction cone formed by friction between the contact point and the contact surface. Accordingly, in the present exemplary embodiment a contact velocity ψᵢ(qₜ, vₜ) of the contact point at the contact surface at the time point t is derived. The contact velocity ψᵢ(qₜ, vₜ) can be represented by the following expression.

$${ψ}_{i} ( {q}_{t} , {v}_{t} ) ∈ ℝ$$

In order to express complementarity conditions relating to contact between bodies, in the present exemplary embodiment two non-negative contact forces λ_{fi+} and λ_{fi-}, which are generated in a horizontal direction of a contact surface, are derived. The two contact forces λ_{fi+} and λ_{fi-} can be represented by the following expression.

$$\begin{matrix}{λ}_{{f}_{i} +} , {λ}_{{f}_{i} -} ∈ {ℝ}_{+} \\ {λ}_{{f}_{i}} = {λ}_{{f}_{i} +} - {λ}_{{f}_{i} -}\end{matrix}$$

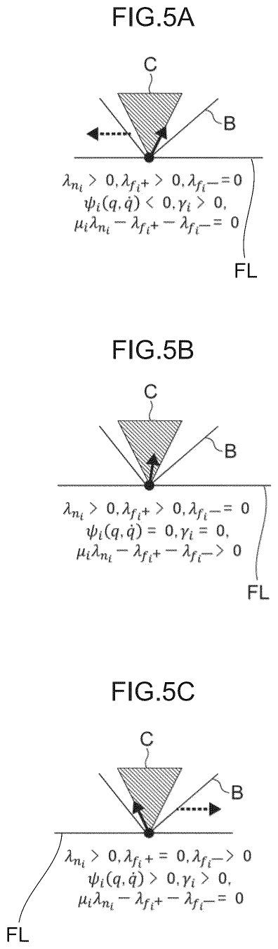

FIG. 5A to FIG. 5C are diagrams for describing a Coulomb friction coefficient between a contact point and contact surface. The black circles depicted in FIG. 5A to FIG. 5C represent contact points, the solid line arrows represent contact forces, and the broken line arrows represent contact velocities. In order for the object body B or the gripper part G to not slide at the contact point, the contact force λₙᵢ generated in the perpendicular direction and the contact forces λ_{fi+} and λ_{fi-} generated in the horizontal direction must have the relationships depicted in FIG. 5A to FIG. 5C. Each solid line arrow shown in FIG. 5A to FIG. 5C represents the contact force and the broken line arrow represents an absolute value γᵢ of a contact velocity ψᵢ(qₜ, vₜ) caused by the object body B slipping. The symbol γᵢ represents a coefficient of friction between the contact point and the contact surface, and μᵢ>0. The absolute value γᵢ is defined by the following expression.

$${γ}_{i} ∈ ℝ$$

In FIG. 5A, the contact force vector λ_{t,i} is located at a right side boundary of a friction cone C. As a result, slippage occurs at the contact point of the object body B. Therefore, in a situation as in FIG. 5A, the following expressions apply at a contact point at which the object body B contacts the floor surface FL.

$$\begin{matrix}{λ}_{{n}_{i}} > 0 , {λ}_{{f}_{i} +} > 0 , {λ}_{{f}_{i} -} = 0 \\ {ψ}_{i} ( q , \dot{q} ) < 0 , {γ}_{i} > 0 , \\ {μ}_{i} {λ}_{{n}_{i}} - {λ}_{{f}_{i} +} - {λ}_{{f}_{i} -} = 0\end{matrix}$$

As shown by the above expressions, in the situation in FIG. 5A, the contact force λₙᵢ has a positive value, the contact force λ_{fi+} generated in a first horizontal direction has a positive value, and the contact force λ_{fi-} generated in a second horizontal direction that is opposite to the first horizontal direction is zero. When the first horizontal direction is positive, a contact velocity ψᵢ(q,q·)=ψᵢ(qₜ, vₜ) is negative, and the absolute value γᵢ of the contact velocity is positive. In the situation in FIG. 5A, a value obtained by subtracting the the contact force λ_{fi+} generated in the first horizontal direction and the contact force λ_{fi-} generated in the second horizontal direction from a friction force μᵢλₙᵢ generated at the contact point is zero. Therefore, slippage occurs at the contact point of the object body B in the situation in FIG. 5A.

In FIG. 5B, the contact force vector λ_{t,i} is located inside the friction cone C. As a result, slippage does not occur at the object body B. Therefore, in a situation as in FIG. 5B, the following expressions apply at the contact point at which the object body B contacts the floor surface FL.

$$\begin{matrix}{λ}_{{n}_{i}} > 0 , {λ}_{{f}_{i} +} > 0 , {λ}_{{f}_{i} -} = 0 \\ {ψ}_{i} ( q , \dot{q} ) = 0 , {γ}_{i} = 0 , \\ {μ}_{i} {λ}_{{n}_{i}} - {λ}_{{f}_{i} +} - {λ}_{{f}_{i} -} > 0\end{matrix}$$

As shown by the above expressions, in the situation in FIG. 5B, the contact force λₙᵢ has a positive value, the contact force λ_{fi+} generated in the first horizontal direction has a positive value, and the contact force λ_{fi-} generated in the second horizontal direction is zero. When the first horizontal direction is positive, the contact velocity ψᵢ(q,q·)=ψᵢ(qₜ, vₜ) is zero, and the absolute value γᵢ of the contact velocity is zero. In the situation in FIG. 5B, a value obtained by subtracting the contact force λ_{fi+} generated in the first horizontal direction and the contact force λ_{fi-} generated in the second horizontal direction from a friction force μᵢλₙᵢ generated at the contact point is positive. Therefore, slippage does not occur at the object body B in the situation in FIG. 5B.

In FIG. 5C, the contact force vector λ_{t,i} is located at the left side boundary of the friction cone C. As a result, slippage occurs at the contact point of the object body B. Therefore, in a situation as in FIG. 5C, the following expressions apply at the contact point at which the object body B contacts the floor surface FL.

$$\begin{matrix}{λ}_{{n}_{i}} > 0 , {λ}_{{f}_{i} +} = 0 , {λ}_{{f}_{i} -} > 0 \\ {ψ}_{i} ( q , \dot{q} ) > 0 , {γ}_{i} > 0 , \\ {μ}_{i} {λ}_{{n}_{i}} - {λ}_{{f}_{i} +} - {λ}_{{f}_{i} -} = 0\end{matrix}$$

As shown by the above expressions, in the situation in FIG. 5C, the contact force λₙᵢ has a positive value, the contact force λ_{fi+} generated in the first horizontal direction is zero, and the contact force λ_{fi-} generated in the second horizontal direction has a positive value. When the first horizontal direction is positive, the contact velocity ψᵢ(q,q·)=ψᵢ(qₜ, vₜ) has a positive value, and the absolute value γᵢ of the contact velocity is a positive value. In the situation in FIG. 5C, a value obtained by subtracting the contact force λ_{fi+} generated in the first horizontal direction and the contact force λ_{fi-} generated in the second horizontal direction from a friction force μᵢλₙᵢ generated at the contact point is zero. Therefore, slippage occurs at the contact point of the object body B in the situation in FIG. 5C.

As shown in FIG. 5A to FIG. 5C, when the contact velocity ψᵢ(qₜ, vₜ) is not zero, one or other of the contact force λ_{fi+} generated in the first horizontal direction and the contact force λ_{fi-} generated in the second horizontal direction is zero. This is because when the contact velocity ψᵢ(qₜ, vₜ) is not zero, one or other of the value of γᵢψᵢ(qₜ,vₜ) and the value of γᵢ-ψᵢ(qₜ, vₜ) is not zero. As described above, ψᵢ(qₜ, vₜ) is a signed contact velocity that is positive in the first direction. As illustrated in FIG. 5A to FIG. 5C, the contact velocity ψᵢ(qₜ, vₜ) has the opposite sign from the contact force λ_{fi+} generated in the first horizontal direction or the contact force λ_{fi-} generated in the second horizontal direction.

Therefore, the following expressions apply as complementarity conditions relating to a contact between bodies.

$$0 \leq {λ}_{{n}_{i}} ⊥ {ϕ}_{i} ( {q}_{t} ) \geq 0 , \qquad ( 4 a )$$

$$0 \leq {λ}_{{f}_{i} +} ⊥ {γ}_{i} + {ψ}_{i} ( {q}_{t} , {v}_{t} ) \geq 0 , \qquad ( 4 b )$$

$$0 \leq {λ}_{{f}_{i} -} ⊥ {γ}_{i} - {ψ}_{i} ( {q}_{t} , {v}_{t} ) \geq 0 , \qquad ( 4 c )$$

$$0 \leq {γ}_{i} ⊥ {μ}_{i} {λ}_{{n}_{i}} - {λ}_{{f}_{i} +} - {λ}_{{f}_{i} -} \geq 0 , \qquad ( 4 d )$$

Expression (4a) is a complementarity condition representing the contact force λₙᵢ being positive when the distance φᵢ(qₜ) between the bodies is zero, and the contact force λₙᵢ being zero when the distance φᵢ(qₜ) between the bodies has a positive value. Expressions (4b) to (4d) are complementarity conditions representing the contact force vector λ_{t,i} being located inside the friction cone C. Expression (4d) is a complementarity condition representing the contact force vector λ_{t,i} being located at the boundary of the friction cone C as illustrated in FIG. 5A to FIG. 5C.

Therefore, the complementarity conditions relating to contact between bodies mentioned above include complementarity condition (4a), complementarity condition (4b), complementarity condition (4c) and complementarity condition (4d). Complementarity condition (4a) is an example of a complementarity condition relating to a contact force generated at a contact point at a control object and a distance between the control object and the contact point. Complementarity conditions (4b) to (4d) are examples of complementarity conditions relating to a linear contact velocity at a control surface contacted by the contact point.

Expression (4a) is a complementarity condition that, for each of plural contact points, in a state qₜ at a time point t, relates to a contact force λₙᵢ generated in the perpendicular direction of the contact surface contacted by the i-th contact point and a distance φᵢ(qₜ) between the i-th contact point and the contact surface.

Expression (4b) is a complementarity condition that, for each of the plural contact points, in the state qₜ at the time point t with a generalized velocity vₜ at the time point t, relates to a contact force λ_{fi+} in the first horizontal direction of the contact surface contacted by the i-th contact point, a signed linear contact velocity ψᵢ(qₜ, vₜ) that is positive in the first horizontal direction of the contact surface, and an absolute value γᵢ of the linear contact velocity.

Expression (4c) is a complementarity condition that, for each of the plural contact points, in the state qₜ at the time point t with the generalized velocity vₜ at the time point t, relates to a contact force λ_{fi-} in the second horizontal direction of the contact surface contacted by the i-th contact point, a signed linear contact velocity ψᵢ(qₜ, vₜ), and the absolute value γᵢ of the linear contact velocity.

Expression (4d) is a complementarity condition that, for each of the plural contact points, relates to the absolute value γᵢ of the linear contact velocity at the contact surface contacted by the i-th contact point, a coefficient of friction μᵢ of the contact surface, the contact force λₙᵢ generated in the perpendicular direction of the contact surface, the contact force λ_{fi+} in the first horizontal direction, and the contact force λ_{fi-} in the second horizontal direction.

When the proposed method described above is applied to a case of movement in three dimensions, pairs of the above expressions (4b) and (4c) are derived for each of diagonal lines of polyhedral cones.

Now, the LCQP of the present exemplary embodiment is formularized. The contact force vector λₜ is defined. The contact force vector λₜ is a vector with the components λ_{fi+}, λ_{fi-} and λₙᵢ in the following expression.

$${[ {λ}_{{f}_{i} +} , {λ}_{{f}_{i} -} , {λ}_{{n}_{i}} ]}^{T} ∈ {ℝ}^{3}$$

The following expression (5) is derived. In the present exemplary embodiment, a state qₜ₊₁ and contact force vector λₜ₊₁ at a time point t+1 are calculated so as to minimize an objective function represented by expression (5), while satisfying the conditions represented by the above expressions (2) to (4d).

$$\frac{1}{2} {( g ( {q}_{t + 1} ) - {g}_{ref} )}^{T} {Q}_{g} ( g ( {q}_{t + 1} ) - {g}_{ref} ) + \frac{1}{2} {v}_{t}^{T} {Q}_{v} {v}_{t} + \frac{1}{2} {λ}_{t + 1}^{T} {Q}_{f} {λ}_{t + 1} , \qquad ( 5 )$$

The symbol g in expression (5) is a general differentiable function, which is a function for mapping the state q into a space of a position and attitude of the gripper part G of the robot 14 and a position and attitude of the object body B. Thus, g(q) is a physical quantity of the control object that corresponds to a state q. The symbol g_{ref} represents a target value vector of this physical quantity. The symbols Q_{g}, Qᵥ and Q_{f} are positive-definite weighting arrays provided in advance, of which Q_{g} represents a task priority level, and Qᵥ and Q_{f} represent normalization terms.

In the LCQP according to the present exemplary embodiment, the constrained non-linear objective function depicted in expression (5) is optimized on the basis of a previously known gradient descent technique and similar concepts. More specifically in the present exemplary embodiment, control to move the robot 14 is implemented by creating descent steps so as to decrease the objective function in expression (5). These descent steps are calculated by solving the linearized objective function in expression (5). In this way, a state qₜ₊₁ and contact force vector λₜ₊₁ representing positions and forces of the gripper part G and the object body B at the next time point t+1 are obtained.

Repeating the creation of descent steps so as to decrease the objective function in expression (5) ultimately reaches a target state q* such that expression (5) is minimized.

The following expression, defined on the basis of Δqₜ and Δλₜ, is derived in order to facilitate handling of the problem in the present exemplary embodiment.

$$\begin{matrix}{q}_{t + 1} = {q}_{t} + Δ {q}_{t} \\ {λ}_{t + 1} = {λ}_{t} + {Δλ}_{t}\end{matrix}$$

When Δqₜ and Δλₜ are sufficiently small, by a quadratic function of Δqₜ and Δλₜ, the target function in expression (5) is approximated to the following expression (6).

$$\frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {{q}_{t}}^{T} {Q}_{{Δ}_{q}} Δ {q}_{t} + \frac{1}{2} {( {λ}_{t} + {Δλ}_{t} )}^{T} {Q}_{f} ( {λ}_{t} + {Δλ}_{t} ) , \qquad ( 6 )$$

The variables in expression (6) are defined by the following expressions.

$${g}_{t} := g ( {q}_{t} ) ,$$

$${G}_{t} := \frac{\partial g}{\partial q} g ( {q}_{t} ) ,$$

$${Q}_{{Δ}_{q}} := \frac{1}{{h}^{2}} {Q}_{v} ,$$

By substituting the aforementioned expression (2) into expression (6), the above expressions (3) to (4d) may be linearized as shown below.

More specifically, the following expressions (7a) to (7d) can be derived by using Δqₜ, Δλₙᵢ, Δλ_{fi+} and Δλ_{fi-} at a time point t to approximate qₜ₊₁, λ_{fi+}, and λ_{fi-} at a time point t+1.

$$0 \leq {λ}_{{n}_{i}} + {Δλ}_{{n}_{i}} ⊥ {ϕ}_{i} ( {q}_{t} ) + {Φ}_{i , q} ( {q}_{t} ) Δ {q}_{t} \geq 0 , \qquad ( 7 a )$$

$$0 \leq {λ}_{{f}_{i} +} + {Δλ}_{{f}_{i} +} ⊥ {γ}_{i} + {ψ}_{i} ( {q}_{t} , {v}_{t} ) + {Ψ}_{i , v} ( {q}_{t} , {v}_{t} ) Δ {q}_{t} \geq 0 , \qquad ( 7 b )$$

$$0 \leq {λ}_{{f}_{i} -} + {Δλ}_{{f}_{i} +} ⊥ {γ}_{i} - {ψ}_{i} ( {q}_{t} , {v}_{t} ) - {Ψ}_{i , v} ( {q}_{t} , {v}_{t} ) Δ {q}_{t} \geq 0 , \qquad ( 7 c )$$

$$and$$

$$0 \leq {γ}_{i} ⊥ {μ}_{i} ( {λ}_{{n}_{i}} + {Δλ}_{{n}_{i}} ) - {λ}_{{f}_{i} +} - {Δλ}_{{f}_{i} +} - {λ}_{{f}_{i} -} - {Δλ}_{{f}_{i} -} \geq 0 , \qquad ( 7 d )$$

The previously undefined variables in the above expressions (7a) to (7d) are defined by the following expressions.

$${Φ}_{i , q} ( q ) := \frac{\partial ϕ}{\partial q} ( q )$$

$${Ψ}_{i , v} ( q , v ) := \frac{\partial ψ}{\partial v} ( q , v )$$

When the LCQP is executed, the following relational expression is substituted into expressions (7a) to (7d).

$${v}_{t} = \frac{Δ {q}_{t}}{h} = 0$$

Therefore, the complementarity conditions relating to contact between bodies mentioned above include a linear complementarity condition (7a), a complementarity condition (7b), a linear complementarity condition (7c) and a linear complementarity condition (7d).

Expression (7a) is a linear complementarity condition that, for each of plural contact points, in a state qₜ at a time point t, relates to a contact force λₙᵢ generated in the perpendicular direction of a contact surface contacted by the i-th contact point, an amount of change Δλₙᵢ of the contact force λₙᵢ, a distance φᵢ(qₜ) between the i-th contact point and the contact surface, Φ_{i,q}(qₜ) that is obtained by differentiating the distance φᵢ(qₜ) with respect to the state qₜ, and an amount of change Δqₜ of the state qₜ.

Expression (7b) is a linear complementarity condition that, for each of the plural contact points, in the state qₜ at the time point t with a generalized velocity vₜ at the time point t, relates to a contact force λ_{fi+} generated in the first horizontal direction of the contact surface contacted by the i-th contact point, an amount of change Δλ_{fi+} of the contact force λ_{fi+}, a signed linear contact velocity Ψᵢ(qₜ, vₜ) that is positive in the first horizontal direction of the contact surface, Ψ_{i,v}(qₜ, vₜ) that is obtained by differentiating the linear contact velocity ψᵢ(qₜ, vₜ) with respect to the generalized velocity vₜ, an absolute value γᵢ of the linear contact velocity, and an amount of change Δqₜ of the state qₜ.

Expression (7c) is a linear complementarity condition that, for each of the plural contact points, in the state qₜ at the time point t with the generalized velocity vₜ at the time point t, relates to a contact force λ_{fi-} generated in the second horizontal direction of the contact surface contacted by the i-th contact point, an amount of change Δλ_{fi-} of the contact force λ_{fi-}, the signed linear contact velocity Vi (qₜ, vₜ), the absolute value γᵢ of the linear contact velocity, and the Ψ_{i,v}(qₜ, vₜ) obtained by differentiating the linear contact velocity ψᵢ(qₜ, vₜ) with respect to the generalized velocity vₜ.

Expression (7d) is a linear complementarity condition that, for each of the plural contact points, relates to the absolute value γᵢ of the linear contact velocity at the contact surface contacted by the i-th contact point, a friction of coefficient μᵢ of the contact surface, the contact force λₙᵢ generated in the perpendicular direction of the contact surface, the amount of change Δλₙᵢ of the contact force λₙᵢ, the contact force λ_{fi+} in the first horizontal direction, the amount of change Δλ_{fi+} of the contact force λ_{fi+} in the first horizontal direction, the contact force λ_{fi-} in the second horizontal direction, and the amount of change Δλ_{fi-} of the contact force λ_{fi-} in the second horizontal direction.

### —Linearizing Forces and Moments—

A relational expression of forces and moments represented by the above expression (3) can be formularized as in the following expression (8).

$$b ( {q}_{t} , \{ {λ}_{t , j} \} ) + \frac{\partial b}{\partial {q}_{t}} ( {q}_{t} , {\{ {λ}_{t , i} \}}_{i ∈ {C}_{0}} ) Δ {q}_{t} + {\sum }_{i ∈ {C}_{0}} \frac{\partial b}{\partial {λ}_{t , i}} ( {q}_{t} , {\{ {λ}_{t , i} \}}_{i ∈ {C}_{0}} ) {Δλ}_{t , i} = 0 \qquad ( 8 )$$

### —Relaxing Complementarity Conditions Relating to Contacts Between Bodies—

In practice, there may be cases in which no solution is available that satisfies the complementarity conditions (7a) to (7c) relating to contact between bodies. For example, there may be situations in which the complementarity conditions (7a) to (7c) relating to contact between bodies cannot be satisfied due to states measured by a sensor or the like including noise or due to a model representing an object body B being incapable of reproducing the actual object body B (for example, a modeling error in a geometric model of the object body B, deformation of the object body B, or the like).

Furthermore, a state may be produced by the complementarity conditions (7a) to (7d) relating to contact between bodies in which the gripper part G of the robot 14, which is an acting body, cannot make contact with the object body B. For example, there may be situations in which a non-zero contact force λₙᵢ in the perpendicular direction is calculated but the actual position of the contact point is slightly apart from the contact surface.

Accordingly, in order to solve these problems in the present exemplary embodiment, small overlaps between the bodies are allowed. More specifically in the present exemplary embodiment, the complementarity conditions relating to contact between bodies are relaxed by including a relaxation variable sᵢ in the expressions (7a) to (7d). The complementarity conditions into which the relaxation variable sᵢ is introduced can be represented by the following expressions.

$$0 \leq {λ}_{{n}_{i}} + {Δλ}_{{n}_{i}} + {s}_{i} ⊥ {ϕ}_{i} ( {q}_{t} ) + {Φ}_{i , q} ( {q}_{t} ) Δ {q}_{t} + {s}_{i} \geq 0 , \qquad ( 9 a )$$

$$0 \leq {λ}_{{f}_{i} +} + {Δλ}_{{f}_{i} +} + {s}_{i} ⊥ {γ}_{i} + {ψ}_{i} ( {q}_{t} , {v}_{t} ) + {Ψ}_{i , v} ( {q}_{t} , {v}_{t} ) Δ {q}_{t} + {s}_{i} \geq 0 , \qquad ( 9 b )$$

$$0 \leq {λ}_{{f}_{i} -} + {Δλ}_{{f}_{i} +} + {s}_{i} ⊥ {γ}_{i} - {ψ}_{i} ( {q}_{t} , {v}_{t} ) - {Ψ}_{i , v} ( {q}_{t} , {v}_{t} ) Δ {q}_{t} + {s}_{i} \geq 0 , \qquad ( 9 c )$$

$$and$$

$$0 \leq {γ}_{i} + {s}_{i} ⊥ {μ}_{i} ( {λ}_{{n}_{i}} + {Δλ}_{{n}_{i}} ) - {λ}_{{f}_{i} +} - {Δλ}_{{f}_{i} +} - {λ}_{{f}_{i} -} - {Δλ}_{{f}_{i} -} + {s}_{i} \geq 0. \qquad ( 9 d )$$

When the above expressions (9a) to (9d) are used, pᵢsᵢ² is added to the objective function in expression (6). The objective function to which pᵢsᵢ² is added can be represented by the following expression (10). Each pᵢ in the expression below is a coefficient specified in advance.

$${min}_{Δ {q}_{t} , {Δλ}_{t} , {s}_{t}} \frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {{q}_{t}}^{T} {Q}_{Δ {q}_{t}} Δ {q}_{t} + \frac{1}{2} {( {λ}_{t} + {Δλ}_{t} )}^{T} {Q}_{f} ( {λ}_{t} + {Δλ}_{t} ) + {\sum }_{i} {p}_{i} {s}_{i}^{2} \qquad ( 10 )$$

$$s . t . ( 8 ) - ( 9 d ) .$$

In the present exemplary embodiment, Δqₜ, Δλₜ and sₜ at a time point t are calculated so as to minimize expression (10). Δqₜ and Δλₜ at the time point t are used for calculating qₜ₊₁=qₜ+Δqₜ and λₜ₊₁=λₜ+Δλₜ at the next time point t+1. The term sₜ is a vector whose components are relaxation variables sᵢ. Because qₜ₊₁ and λₜ₊₁ include positions and forces of an acting system (the gripper part G of the robot 14 in the present exemplary embodiment) as elements, movements of the gripper part G of the robot 14 are controlled in accordance with qₜ₊₁ and λₜ₊₁.

Values calculated by the LCQP are converted to control signals qₜ₊₁^{˜} relating to positions of the gripper part G by the following expression.

$${\tilde{q}}_{t + 1} = {q}_{t + 1} - \frac{1}{K} {λ}_{t + 1}$$

In this expression, K is greater than zero and is a gain defined by a user. Situations in which the robot 14 cannot in reality accurately implement force command signals calculated by the LCQP are suppressed by the above conversion.

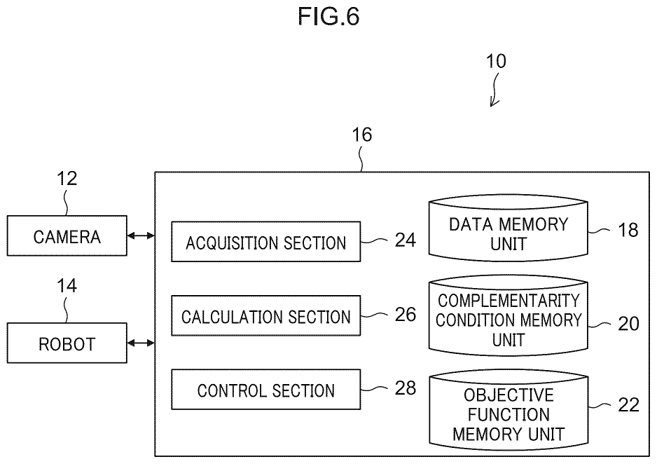

FIG. 6 is a block diagram showing schematic structures of a control system 10 according to the present exemplary embodiment that is controlled by the LCQP. As shown in FIG. 6, the control system 10 is provided with a camera 12, the robot 14 and the control device 16. The control device 16 according to the present exemplary embodiment continuously controls movements of the robot 14 so as to satisfy the complementarity conditions relating to contact between bodies (for example, between the gripper part G of the robot 14, the object body B, the wall W and the floor surface FL).

The camera 12 successively images the gripper part G of the robot 14 and the object body B that are control objects. The camera 12 outputs image data obtained by the imaging of the gripper part G of the robot 14 and the object body B to the control device 16.

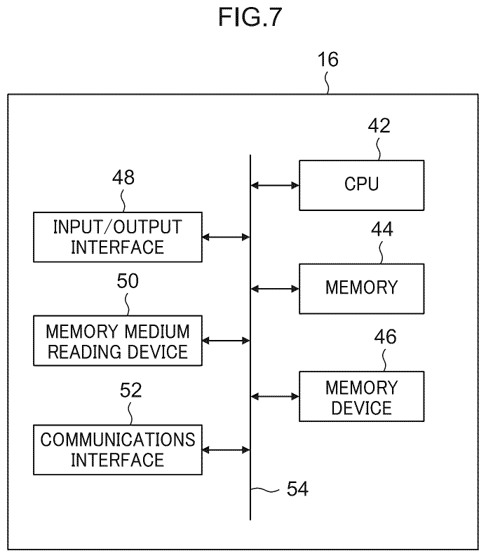

FIG. 7 is a block diagram showing hardware structures of the control device 16 according to the present exemplary embodiment. As shown in FIG. 7, the control device 16 includes a central processing unit (CPU) 42, memory 44, a memory device 46, an input/output interface (I/F) 48, a memory medium reading device 50 and a communications interface 52. These structures are connected to be capable of communicating with one another via a bus 54.

The memory device 46 stores a control program for executing the processing described below. The CPU 42 is a central arithmetic processing unit, which executes various programs and controls various structures. That is, the CPU 42 reads the program from the memory device 46 and executes the program using the memory 44 as a work area. The CPU 42 conducts control of the above-mentioned structures and various computations in accordance with the program memorized at the memory device 46.

The memory 44 is structured by random access memory (RAM) and serves as a work area, temporarily memorizing the program and data. The memory device 46 is structured by read-only memory (ROM), a hard disk drive (HDD), a solid state drive (SSD) or the like. The memory device 46 stores various programs, including an operating system, and various kinds of data.

The input/output interface 48 is an interface for inputting data from the camera 12 and the robot 14 and outputting data to the camera 12 and robot 14. An entry device for performing various kinds of entry such as, for example, a keyboard and mouse or the like and an output device for outputting various kinds of information such as, for example, a display screen, printer or the like may be connected to the input/output interface 48. If a touch panel display is employed as the output device, the touch panel display may also function as the entry device.

The memory medium reading device 50 reads data memorized at various types of memory medium, such as a compact disc (CD)-ROM, digital versatile disc (DVD-ROM), Blu-ray disc, universal serial bus (USB) memory or the like, writes data to the memory medium, and so forth.

The communications interface 52 is an interface for communicating with other equipment using a standard such as, for example, Ethernet (registered trademark), FDDI, Wi-Fi (registered trademark) or the like.

Now, functional structures of the control device 16 are described. As shown in FIG. 6, functionally, the control device 16 includes an acquisition section 24, a calculation section 26 and a control section 28.

A data memory unit 18, a complementarity condition memory unit 20 and an objective function memory unit 22 are provided in predetermined memory regions of the control device 16. The functional structures are realized by the CPU 42 reading a program memorized at the memory device 46, loading the program into the memory 44 and executing the program.

Image data captured by the camera 12 is stored in the data memory unit 18. Data of the above-described complementarity conditions relating to contact between bodies is stored in the complementarity condition memory unit 20. Data relating to the above-described objective function is stored in the objective function memory unit 22.

The acquisition section 24 successively acquires image data, which is an example of sensor data obtained by sensing, from the gripper part G of the robot 14 and the object body B that are control objects. The acquisition section 24 stores the acquired image data in the data memory unit 18.

The acquisition section 24 acquires a state qₜ of the robot 14 and the object body B at a time point t. More specifically, the acquisition section 24 reads image data for the time point t that has been stored in the data memory unit 18 and calculates data representing the state qₜ at the time point t. The acquisition section 24 uses previously known technology to calculate the data representing the state qₜ from the image data.

On the basis of the state qₜ at the time point t calculated by the acquisition section 24, the calculation section 26 calculates a state qₜ₊₁ of the robot 14 and object body B at a time point t+1 so as to satisfy the aforementioned complementarity conditions relating to contact between bodies and minimize the objective function representing a difference between a target value and the state qₜ₊₁ at the time point t+1. The calculation section 26 executes this calculation processing while referring to the data of complementarity conditions relating to contact between bodies stored in the complementarity condition memory unit 20 and the data relating to the objective function stored in the objective function memory unit 22.

In the present exemplary embodiment, each complementarity condition relating to contact between bodies is a complementarity condition relating to a contact force generated between any two of a contact point of the gripper part G of the robot 14, a contact point of the object body B, and a contact point of the wall W or floor surface FL, which is another body, and to a distance between the any two of the contact point of the gripper part G of the robot 14, the contact point of the object body B and the contact point of the wall W or floor surface FL. The complementarity conditions relating to contact between the bodies are any of the aforementioned expressions (4a) to (4d), expressions (7a) to (7d) and expressions (9a) to (9d).

Therefore, for example, the calculation section 26 calculates pairs of states Δqₜ and contact forces Δλₜ so as to satisfy the complementarity conditions (9a) to (9d) relating to contact between the bodies and to minimize the objective function in expression (10) including an element that is a difference between gₜ and g_{ref}, which is a parameter of the state qₜ. On the basis of the pairs of states Δqₜ and contact forces Δλₜ, the calculation section 26 then calculates, for the time point t+1, qₜ₊₁, which is qₜ+Δqₜ, and λₜ₊₁, which is λₜ+λₜ.

The control section 28 controls movement of the gripper part G of the robot 14 that is the control object so as to achieve the state qₜ₊₁ calculated by the calculation section 26 at the time point t+1. For example, the control section 28 controls movement of the gripper part G of the robot 14 by employing a previously known technology.

Now, operation of the control system 10 according to the present exemplary embodiment is described.

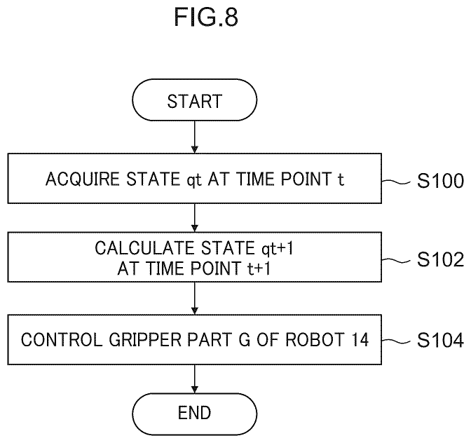

Firstly, when the control system 10 receives predetermined command signals in an environment in which the object body B is placed, the CPU 42 of the control device 16 reads the control program from the memory device 46, loads the program into the memory 44, and executes the program. Accordingly, the CPU 42 functions as the functional structures of the control device 16 and executes the control processing shown in FIG. 8. The control processing shown in FIG. 8 is executed repeatedly.

Below, an example is described in which the above expressions (9a) to (9d) are used as the complementarity conditions relating to contact between bodies and the above expression (10) is used as the objective function. Accordingly, data relating to expressions (9a) to (9d) is stored in the complementarity condition memory unit 20 and data relating to expression (10) is stored in the objective function memory unit 22.

In step S100, the acquisition section 24 reads image data of a time point t stored in the data memory unit 18 and acquires data representing the state qₜ at the time point t.

In step S102, the calculation section 26 reads the data relating to expressions (9a) to (9d) from the complementarity condition memory unit 20. Meanwhile in step S102, the calculation section 26 reads the data relating to expression (10) from the objective function memory unit 22. Also in step S102, on the basis of the state qₜ at the time point t acquired in step S100, the calculation section 26 calculates a state qₜ₊₁ at a time point t+1 such that the complementarity conditions in expressions (9a) to (9d) relating to contact between bodies are satisfied and such that the objective function in expression (10) representing the difference between the target value and the state qₜ₊₁ of the robot 14 and object body B at the time point t+1 is minimized.

In step S104, the control section 28 controls movement of the gripper part G of the robot 14 that is a control object so as to achieve the state qₜ₊₁ calculated in step S102 at the time point t+1.

As a result of the control processing shown in FIG. 8 being repeated and control signals being repeatedly outputted to the robot 14, a desired position and attitude of the object body B is achieved.

As described above, the control device of the control system according to the present exemplary embodiment acquires a state of a control object at a time point t and, on the basis of the state at the time point t, calculates a state at a time point t+1 so as to satisfy a complementarity condition relating to a contact force generated at a contact point at the control object and a distance between the control object and the control point, and so as to minimize an objective function representing a difference between the state of the control object at the time point t+1 and a target value. Then the control device controls the control object so as to achieve the calculated state at the time point t+1. Thus, the control object may be controlled so as to satisfy the complementarity condition relating to a control force generated at a contact point at a control object and a distance between the control object and the contact point.

According to the control device according to the present exemplary embodiment, a control object that is a robot may be controlled continuously.

In the present exemplary embodiment, the complementarity conditions of the above expressions (4a) to (4d) are linearized to create the linearized complementarity conditions of the above expressions (7a) to (7d). Consequently, calculation costs required for computing of the complementarity conditions may be reduced, and movement commands for the robot according to states of the gripper part G of the robot 14 and the object body B may be computed over a network. Hence, movements may be realized to, for example, push the object body B with a distal end of the gripper part G of the robot 14 and stand up the object body B (without gripping the object body B).

In the present exemplary embodiment, the relaxation variable sᵢ is introduced into the complementarity conditions of expressions (7a) to (7d). Consequently, even if there is noise in contacts between bodies in the real world and in contacts between bodies detected by sensor data, whether or not the complementarity conditions relating to contacts between the bodies are satisfied may be calculated, and movements of the gripper part G of the robot 14 may be controlled appropriately.

### Example

Now, an Example is described. In the present Example, a simulation is conducted using PYBULLET 3D PHYSICS SIMULATOR (E. Coumans and Y. Bai, “Pybullet, a python module for physics simulation for games, robotics and machine learning,” 2016-2021. [Online]. Available: http://pybullet.org) in order to experimentally verify the effectiveness of the proposed LCQP.

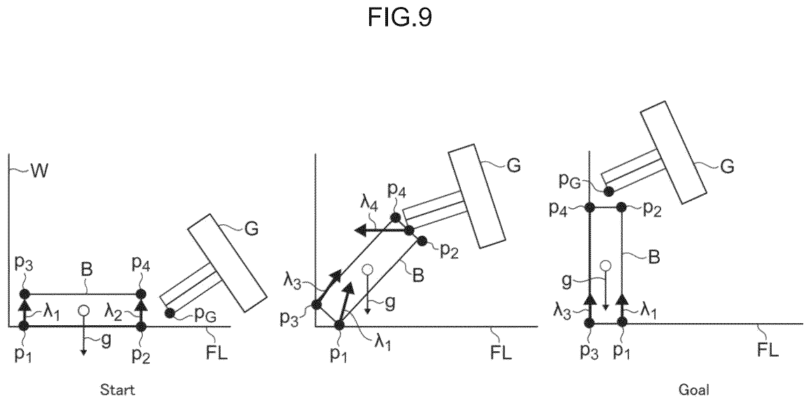

FIG. 9 is a diagram for describing the present Example. As shown in FIG. 9, in the present Example, a simulation is conducted in which a distal end of a gripper part G of a robot is put into contact with an object body B, which is a box lying flat, so as to stand up the box. The present Example employs the complementarity conditions of expressions (7a) to (7d) in which a relaxation variable is included.

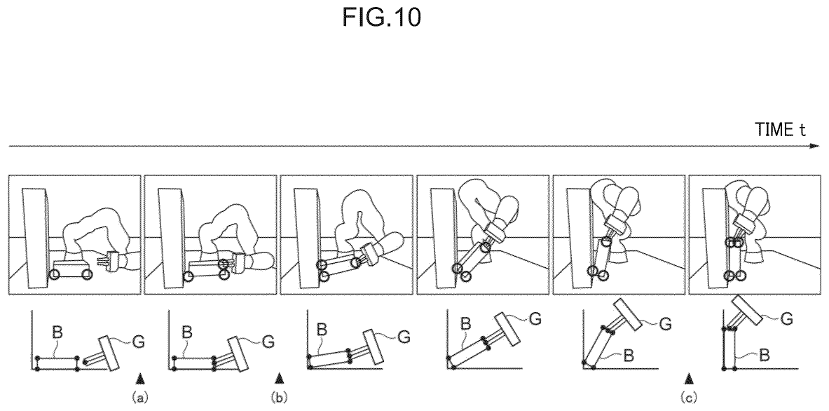

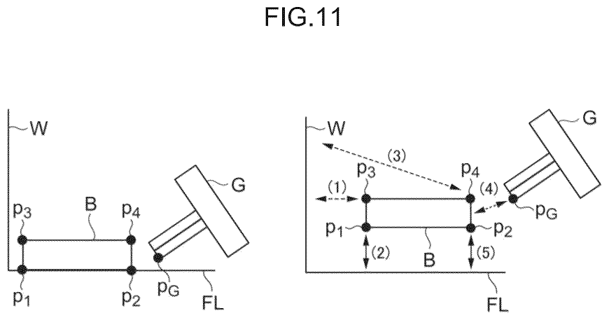

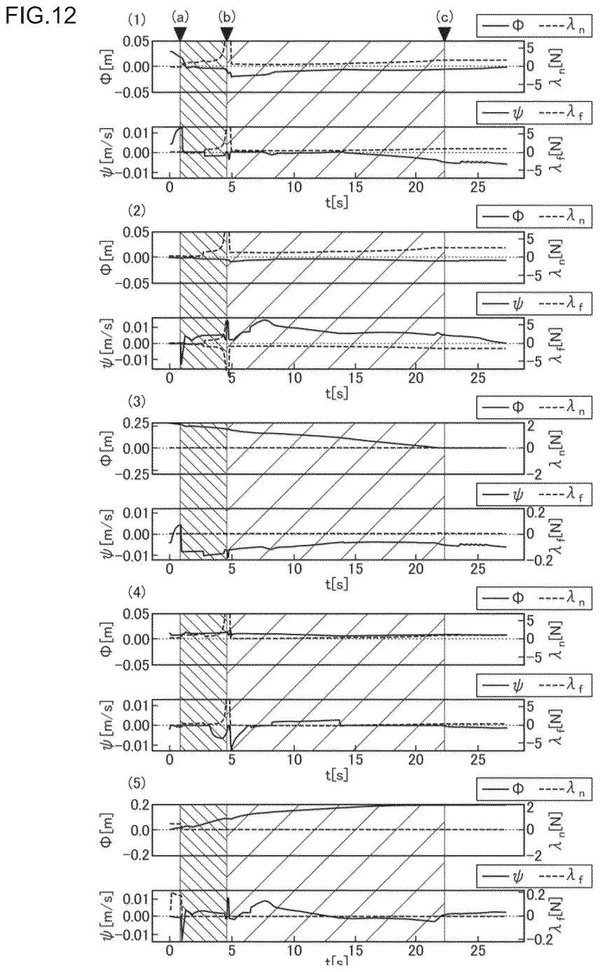

FIG. 10 and FIG. 12 are diagrams depicting results of the present Example. FIG. 11 is a diagram for explaining the results of the present Example.

As shown in FIG. 10, it is seen that the gripper part G of the robot can touch the box that is the object body B and stand up the object body B. FIG. 12 is a diagram depicting results when parameters relating to the contact points shown in FIG. 11 are monitored at respective times. As shown in (1) to (5) of FIG. 12, it is seen that the complementarity conditions relating to contact are satisfied by the respective parameters of contact points p1 to p4. For example, as shown in FIG. 10 and FIG. 11, the contact point p3 makes contact with the wall W between times (a) and (b). Referring to (1) in FIG. 12, forces λₙ and λ_{f} are generated between the times (a) and (b). Meanwhile, φ and ψ have values close to zero between the times (a) and (b) in FIG. 12. Thus, as shown in (1) to (5) of FIG. 12, it is seen that the complementarity conditions relating to contact are satisfied by the respective parameters at the contact points p1 to p4.

In the exemplary embodiment described above, an example is described in which the LCQP of the present disclosure is applied to robot control, but this is not limiting. The LCQP is likely to be applicable to an object for which a control system with many parameters requires optimization in real time. For example, in addition to body operations that switch between contact states, the LCQP may be applied to movement of a legged robot or a wheeled robot. Robots that perform body operations to switch between contact states are required in many situations of moving items around, referred to as pick-and-place in cramped environments and the like, and thus the LCQP may be applied to these robots. The LCQP may also be applied when conducting operations of autonomous manipulators such as in experiment automation, component assembly and the like. A wheeled robot touches and runs along a wall, a floor surface or the like. Therefore, friction forces are generated between the robot and the wall or floor surface. Thus, the LCQP employing complementarity conditions relating to contacts may also be applied to wheeled robots.

The processing that, in the exemplary embodiment described above, is executed by a CPU reading software (a program) may be executed by various kinds of processor other than a CPU. Examples of processors in these cases include a PLD (programmable logic device) in which a circuit configuration can be modified after manufacturing, such as an FPGA (field-programmable gate array) or the like, a dedicated electronic circuit which is a processor with a circuit configuration that is specially designed to execute specific processing, such as an ASIC (application-specific integrated circuit) or the like, and so forth. The processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

In the exemplary embodiment described above, a mode is described in which a program is memorized in advance (for example, installed) at a memory device, but this is not limiting. The program may be provided in a form memorized on a recording medium such as a CD-ROM, DVD-ROM, Blu-ray disc, Flash memory or the like. Modes are also possible in which the program is downloaded from external equipment via a network.

The disclosures of Japanese Patent Application No. 2022-168713 filed Oct. 20, 2022 are incorporated into the present specification by reference in their entirety. All references, patent applications and technical specifications cited in the present specification are incorporated by reference into the present specification to the same extent as if the individual references, patent applications and technical specifications were specifically and individually recited as being incorporated by reference.

1. A control device comprising:
an acquisition section that acquires a state of a control object at a time point t;
a calculation section that, on the basis of the state at the time point t, calculates a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and
a control section that controls the control object so as to achieve the calculated state at the time point t+1.

2. The control device according to claim 1, wherein the calculation section, on the basis of the state at the time point t, calculates the state at the time point t+1 so as to satisfy
the complementarity condition relating to the contact force generated at the contact point at the control object and the distance between the control object and the contact point and
a complementarity condition relating to a linear contact velocity at a contact surface contacted by the contact point,
and so as to minimize the objective function representing the difference between the state of the control object at the time point t+1 and the target value.

3. The control device according to claim 1, wherein
the control object is each of a robot and an object body,
data of the states is calculated on the basis of sensor data obtained by a sensor that senses states of the robot and the object body, and
the calculation section, on the basis of the states at the time point t, calculates the states of the control objects at the time point t+1 so as to satisfy complementarity conditions that each relate to
a contact force generated between two of a contact point of the robot, a contact point of the object body, and a contact point of another body, and
a distance between the two of the contact point of the robot, the contact point of the object body, and the contact point of the another body.

4. The control device according to claim 3, wherein the complementarity conditions include, for each of a plurality of the contact points:
a complementarity condition (4a) relating to, in the state qₜ at the time point t, a contact force λₙᵢ generated in a perpendicular direction of a contact surface contacted by an i-th contact point and a distance φᵢ(qₜ) between the i-th contact point and the contact surface;
a complementarity condition (4b) relating to, in the state qₜ at the time point t with a generalized velocity vₜ at the time point t, a contact force λ_{fi+} in a first horizontal direction of the contact surface contacted by the i-th contact point, a signed linear contact velocity γᵢ(qₜ,vₜ) that is positive in the first horizontal direction of the contact surface, and an absolute value γᵢ of the linear contact velocity;
a complementarity condition (4c) relating to, in the state qₜ at the time point t with the generalized velocity vₜ at the time point t, a contact force λ_{fi-} in a second horizontal direction of the contact surface contacted by the i-th contact point, the signed linear contact velocity ψᵢ(qₜ,vₜ), and the absolute value γᵢ of the linear contact velocity; and
a complementarity condition (4d) relating to, at the contact surface contacted by the i-th contact point, the absolute value γᵢ of the linear contact velocity, a coefficient of friction μᵢ of the contact surface, the contact force λₙᵢ generated in the perpendicular direction of the contact surface, the contact force λ_{fi+} in the first horizontal direction, and the contact force λ_{fi-} in the second horizontal direction
$$0 \leq {λ}_{{n}_{i}} ⊥ {ϕ}_{i} ( {q}_{t} ) \geq 0 , \qquad ( 4 a )$$
$$0 \leq {λ}_{{f}_{i} +} ⊥ {γ}_{i} + {ψ}_{i} ( {q}_{t} , {v}_{t} ) \geq 0 , \qquad ( 4 b )$$
$$0 \leq {λ}_{{f}_{i} -} ⊥ {γ}_{i} - {ψ}_{i} ( {q}_{t} , {v}_{t} ) \geq 0 , \qquad ( 4 c )$$
$$0 \leq {γ}_{i} ⊥ {μ}_{i} {λ}_{{n}_{i}} - {λ}_{{f}_{i} +} - {λ}_{{f}_{i}} \geq 0. \qquad ( 4 d )$$

5. The control device according to claim 4, wherein the calculation section, on the basis of the state qₜ at the time point t, calculates the state qₜ₊₁ at the time point t+1 so as to satisfy the complementarity conditions (4a) to (4d) and minimize an objective function (5)
$$\frac{1}{2} {( g ( {q}_{t + 1} ) - {g}_{ref} )}^{T} {Q}_{g} ( g ( {q}_{t + 1} ) - {g}_{ref} ) + \frac{1}{2} {v}_{t}^{T} {Q}_{v} {v}_{t} + \frac{1}{2} {λ}_{t + 1}^{T} {Q}_{f} {λ}_{t + 1} , \qquad ( 5 )$$
in which g(qₜ+1) represents a physical quantity of the control object corresponding to the state qₜ₊₁, g_{ref} represents a target value of the physical quantity of the control object corresponding to the target value in the state qₜ₊₁, Q_{g}, Qᵥ and Q_{f} represent positive-definite weighting arrays provided in advance, and λₜ₊₁ represents a vector at the time point t+1 for each of the plurality of contact points, components of the vector being the contact force λₙᵢ generated in the perpendicular direction of the contact surface, the contact force λ_{fi+} in the first horizontal direction and the contact force λ_{fi-} in the second horizontal direction.

6. The control device according to claim 3, wherein the complementarity conditions include, for each of a plurality of the contact points:
a linear complementarity condition (7a) relating to, in the state qₜ at the time point t, a contact force λₙᵢ generated in a perpendicular direction of a contact surface contacted by an i-th contact point, an amount of change Δλₙᵢ of the contact force λₙᵢ, a distance φᵢ(qₜ) between the i-th contact point and the contact surface, Φ_{i,q}(qₜ) obtained by differentiating the distance φᵢ(qₜ) with respect to the state qₜ, and an amount of change Δqₜ of the state qₜ;
a linear complementarity condition (7b) relating to, in the state qₜ at the time point t with a generalized velocity vₜ at the time point t, a contact force λ_{fi+} in a first horizontal direction of the contact surface contacted by the i-th contact point, an amount of change Δλ_{fi+} of the contact force λ_{fi+}, a signed linear contact velocity ψᵢ(qₜ,vₜ) that is positive in the first horizontal direction of the contact surface, Ψ_{i,v}(qₜ, vₜ) obtained by differentiating the linear contact velocity ψᵢ(qₜ,vₜ) with respect to the generalized velocity vₜ, an absolute value γᵢ of the linear contact velocity, and an amount of change Δqₜ of the state qₜ;
a linear complementarity condition (7c) relating to, in the state qₜ at the time point t with the generalized velocity vₜ at the time point t, a contact force λ_{fi-} in a second horizontal direction of the contact surface contacted by the i-th contact point, an amount of change Δλ_{fi-} of the contact force λ_{fi-}, the signed linear contact velocity ψᵢ(qₜ,vₜ), the absolute value γᵢ of the linear contact velocity, and the Ψ_{i,v}(qₜ,vₜ) obtained by differentiating the linear contact velocity ψᵢ(qₜ, vₜ) with respect to the generalized velocity vₜ; and
a linear complementarity condition (7d) relating to, at the contact surface contacted by the i-th contact point, the absolute value γᵢ of the linear contact velocity, a coefficient of friction ρᵢ of the contact surface, the contact force λₙᵢ generated in the perpendicular direction of the contact surface, the amount of change Δλₙᵢ of the contact force λₙᵢ, the contact force λ_{fi+} in the first horizontal direction, the amount of change Δλ_{fi+} of the contact force λ_{fi+} in the first horizontal direction, the contact force λ_{fi-} in the second horizontal direction, and the amount of change Δλ_{fi-} of the contact force λ_{fi-} in the second horizontal direction
$$0 \leq {λ}_{{n}_{i}} + {Δλ}_{{n}_{i}} ⊥ {ϕ}_{i} ( {q}_{t} ) + {Φ}_{i , q} ( {q}_{t} ) Δ {q}_{t} \geq 0 , \qquad ( 7 a )$$
$$0 \leq {λ}_{{f}_{i} +} + {Δλ}_{{f}_{i} +} ⊥ {γ}_{i} + {ψ}_{i} ( {q}_{t} , {v}_{t} ) + {Ψ}_{i , v} ( {q}_{t} , {v}_{t} ) Δ {q}_{t} \geq 0 , \qquad ( 7 b )$$
$$0 \leq {λ}_{{f}_{i} -} + {Δλ}_{{f}_{i} +} ⊥ {γ}_{i} - {ψ}_{i} ( {q}_{t} , {v}_{t} ) - {Ψ}_{i , v} ( {q}_{t} , {v}_{t} ) Δ {q}_{t} \geq 0 , \qquad ( 7 c )$$
$$0 \leq {γ}_{i} ⊥ {μ}_{i} ( {λ}_{{n}_{i}} + {Δλ}_{{n}_{i}} ) - {λ}_{{f}_{i} +} - {Δλ}_{{f}_{i} +} - {λ}_{{f}_{i} -} - {Δλ}_{{f}_{i} -} \geq 0 , \qquad ( 7 d )$$

7. The control device according to claim 6, wherein the calculation section, on the basis of the state q, at the time point t, calculates the state qₜ₊₁ at the time point t+1 by calculating an amount of change Δqₜ of the state so as to satisfy the complementarity conditions (7a) to (7d) and minimize an objective function (6)
$$\frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {{q}_{t}}^{T} {Q}_{{Δ}_{q}} Δ {q}_{t} + \frac{1}{2} {( {λ}_{t} + {Δλ}_{t} )}^{T} {Q}_{f} ( {λ}_{t} + {Δλ}_{t} ) , \qquad ( 6 )$$
$${g}_{t} := g ( {q}_{t} ) ,$$
$${G}_{t} := \frac{\partial g}{\partial q} g ( {q}_{t} ) ,$$
$${Q}_{{Δ}_{q}} := \frac{1}{{h}^{2}} {Q}_{v} ,$$
$${q}_{t + 1} = {q}_{t} + {hv}_{t} ,$$
in which gt represents a physical quantity of the control object corresponding to the state qₜ, g_{ref} represents a target value of the physical quantity of the control object corresponding to the target value in the state qₜ, Q_{g}, Qᵥ and Q_{f} represent positive-definite weighting arrays provided in advance, λₜ represents a vector at the time point t for each of the plurality of contact points, components of the vector being the contact force λₙᵢ generated in the perpendicular direction of the contact surface, the contact force λ_{fi+} in the first horizontal direction and the contact force λ_{fi-} in the second horizontal direction, and Δλₜ represents an amount of change of λₜ.

8. The control device according to claim 5, wherein the complementarity conditions include a relaxation variable s, as below for relaxing the complementarity conditions
$$0 \leq {λ}_{{n}_{i}} + {Δλ}_{{n}_{i}} + {s}_{i} ⊥ {ϕ}_{i} ( {q}_{t} ) + {Φ}_{i , q} ( {q}_{t} ) Δ {q}_{t} + {s}_{i} \geq 0 , \qquad ( 9 a )$$
$$0 \leq {λ}_{{f}_{i} +} + {Δλ}_{{f}_{i} +} + {s}_{i} ⊥ {γ}_{i} + {ψ}_{i} ( {q}_{t} , {v}_{t} ) + {Ψ}_{i , v} ( {q}_{t} , {v}_{t} ) Δ {q}_{t} + {s}_{i} \geq 0 , \qquad ( 9 b )$$
$$0 \leq {λ}_{{f}_{i} -} + {Δλ}_{{f}_{i} +} + {s}_{i} ⊥ {γ}_{i} - {ψ}_{i} ( {q}_{t} , {v}_{t} ) - {Ψ}_{i , v} ( {q}_{t} , {v}_{t} ) Δ {q}_{t} + {s}_{i} \geq 0 , \qquad ( 9 c )$$
$$0 \leq {γ}_{i} + {s}_{i} ⊥ {μ}_{i} ( {λ}_{{n}_{i}} + {Δλ}_{{n}_{i}} ) - {λ}_{{f}_{i} +} - {Δλ}_{{f}_{i} +} - {λ}_{{f}_{i} -} - {Δλ}_{{f}_{i} -} + {s}_{i} \geq 0. \qquad ( 9 d )$$

9. The control device according to claim 8, wherein the calculation section, on the basis of the state qₜ at the time point t, calculates the state qₜ₊₁ at the time point t+1 by calculating a vector sₜ so as to satisfy the complementarity conditions (9a) to (9d) and minimize an objective function (10), components of the vector sₜ being an amount of change Δqₜ of the state, an amount of change Δλₜ of the contact force and the relaxation variable sᵢ
$${min}_{Δ {q}_{t} , {Δλ}_{t} , {s}_{t}} \frac{1}{2} {( {g}_{t} + {G}_{t} Δ {q}_{t} - {g}_{ref} )}^{T} {Q}_{g} ( {g}_{t} + {G}_{t} Δ {q}_{t} - {g}_{ref} ) + \frac{1}{2} Δ {{q}_{t}}^{T} {Q}_{Δ {q}_{t}} Δ {q}_{t} + \frac{1}{2} {( {λ}_{t} + {Δλ}_{t} )}^{T} {Q}_{f} ( {λ}_{t} + {Δλ}_{t} ) + {\sum }_{i} {p}_{i} {s}_{i}^{2}$$
$$s . t . ( 8 ) - ( 9 d ) .$$
$${g}_{t} := g ( {q}_{t} ) ,$$
$${G}_{t} := \frac{\partial g}{\partial q} g ( {q}_{t} ) ,$$
$${Q}_{{Δ}_{q}} := \frac{1}{{h}^{2}} {Q}_{v} ,$$
$${q}_{t + 1} = {q}_{t} + {hv}_{t} ,$$
in which gt represents a physical quantity of the control object corresponding to the state qₜ, g_{ref} represents a target value of the physical quantity of the control object corresponding to the target value in the state qₜ, Q_{g}, Qᵥ and Q_{f} represent positive-definite weighting arrays provided in advance, λₜ represents a vector at the time point t for each of the plurality of contact points, components of the vector being the contact force λₙᵢ generated in the perpendicular direction of the contact surface, the contact force λ_{fi+} in the first horizontal direction and the contact force λ_{fi-} in the second horizontal direction, and Δλₜ represents an amount of change of λₜ.

10. A control method comprising a computer executing processing including:
acquiring a state of a control object at a time point t;
on the basis of the state at the time point t, calculating a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and
controlling the control object so as to achieve the calculated state at the time point t+1.

11. A non-transitory storage medium storing a control program that is executable by a computer to execute processing comprising:
acquiring a state of a control object at a time point t;
on the basis of the state at the time point t, calculating a state of the control object at a time point t+1 so as to satisfy a complementarity condition and minimize an objective function, the complementarity condition relating to a contact force generated at a contact point at the control object and a distance between the control object and the contact point, and the objective function representing a difference between the state at the time point t+1 and a target value; and
controlling the control object so as to achieve the calculated state at the time point t+1.
